(19) United States
(12) Patent Application Publication
(10) Pub. No.: US 2016/0203296 A1
(43) Pub. Date: Jul. 14, 2016

(54) SYSTEM AND METHOD FOR DETERMINING A CLINICAL TRIAL PATIENT BURDEN

(71) Applicant: Medidata Solutions, Inc., New York, NY (US)

(72) Inventors: Christopher Bound, Perkasie, PA (US); Joshua Hartman, Fort Washington, PA (US); Michelle Marlborough, Brooklyn, NY (US); Anne Zielinski, Jenkintown, PA (US); David McNierney, New York, NY (US); Rafael Campo, Wyncote, PA (US)

(21) Appl. No.: 14/857,373

(22) Filed: Sep. 17, 2015

Related U.S. Application Data
(60) Provisional application No. 62/103,283, filed on Jan. 14, 2015.

(51) Int. Cl. G06F 19/00

(52) U.S. Cl. CPC G06F 19/363; G06F 19/345

(57) ABSTRACT

An improved clinical trial patient burden calculating system includes a data analyzer to calculate scores and weights for patient burden components, a plurality of data calculators to calculate a respective plurality of sub patient burden indexes based on the patient burden component scores and weights, and an aggregator to calculate a procedure-level patient burden index based on aggregation of the sub patient burden indexes. An improved method for calculating clinical trial patient burden is also described and claimed.

### CLAIM OF PRIORITY

This application claims priority from U.S. Provisional Application No. 62/103,283, filed on Jan. 14, 2015, which is incorporated by reference in its entirety.

### BACKGROUND

A clinical trial tests the safety and efficacy of a medical treatment or intervention, such as a new drug or a behavior change, on patients or subjects. Participation in a clinical trial activity or an entire clinical trial is often burdensome to such patients. Understanding and assessing patient burden index (“PBI”), which is a measure of such a patient burden, may help the different parties involved in a clinical trial, such as hospitals, doctors (principal investigators), nurses, patients, trial designers, pharmaceutical sponsors (e.g., drug manufacturers), contract research organizations (CROs), and site monitors, to design, conduct, and participate in clinical trials. A practical and realistic determination of patient burden index would be valuable for a wide range of clinical trials.

### BRIEF DESCRIPTION OF THE DRAWINGS

FIGS. 1A and 1B are tables showing examples of scoring and weighting schemes to show how the PBI for a serial cerebrospinal fluid (CSF) collection procedure may be calculated, according to embodiments of the present invention;

FIG. 2A is a block diagram of a system for calculating PBIs for a clinical trial, according to an embodiment of the present invention;

FIG. 2B shows data pre-processor and analyzer 50 from the system of FIG. 2A in more detail, according to an embodiment of the present invention;

FIG. 3 is a block diagram of a PBI calculator for calculating a procedure-level PBI, according to an embodiment of the present invention;

FIG. 4 is a flowchart illustrating how a clinical trial procedure-level PBI may be determined, according to an embodiment of the present invention;

FIG. 5A is a table showing an example of calculating the PBI for a blood draw procedure based on the perspective of a 50-year-old male cancer patient;

FIG. 5B is a table showing an example of calculating the PBI for a blood draw procedure based on the perspective of an 80-year-old male cancer patient;

FIG. 6A is a table showing an example of calculating the PBI for a lung biopsy procedure based on the perspective of a 50-year-old male cancer patient;

FIG. 6B is a table showing an example of calculating the PBI for a lung biopsy procedure based on the perspective of an 80-year-old male cancer patient; and

FIG. 7 is a flowchart illustrating how a clinical-trial-level PBI may be determined, according to an embodiment of the present invention.

Where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of embodiments of the invention. However, it will be understood by those of ordinary skill in the art that the embodiments of the present invention may be practiced without these specific details. In other instances, well-known methods, procedures, components, and circuits have not been described in detail so as not to obscure the present invention.

Entities such as hospitals, doctors (principal investigators), nurses, patients, trial designers, sponsors, CROs, and site monitors that are involved in a clinical trial may benefit from understanding the patient burden associated with a particular clinical activity or procedure (e.g., blood draw, x-ray, biopsy, surgery, questionnaire, etc.) and with the trial as a whole. Such benefits may include minimizing the burden imposed on a patient in participating in a clinical trial, determining the feasibility of a clinical trial, and optimizing clinical trial design by linking and assessing a particular patient burden index to a specific objective and endpoint of the overall clinical trial.

Conventional ways of determining patient burden do not take into consideration the patient's perspective in relation to the different patient burden components. Such components associated with a particular clinical trial procedure may include the associated invasiveness of the procedure towards the patient, pain experienced by the patient, and inconvenience caused to the patient. Prior methods of assessing patient burden were qualitative at best, involving providing to a patient a protocol and asking that patient whether he or she would participate in the clinical trial. Such a process does not provide quantitative information or allow trial designers to determine whether one protocol would be more acceptable, because it is less burdensome, to a patient than another.

Given this inadequacy, a method and a system for determining a realistic and useful PBI have been developed by taking into account an objective score for each patient burden component of a clinical trial procedure, and also the perspective of the patient regarding each particular patient burden component. Each patient burden component may be objectively scored based on collected data; the perspective of the patient regarding each particular patient burden component may be taken into account by applying a weighting scheme to the determination of the PBI for the particular clinical trial procedure. Such a weighting scheme may be determined based on patient surveys and feedback, which may be provided using a “patient cloud” of information, or be determined based on inputs from subject matter experts.

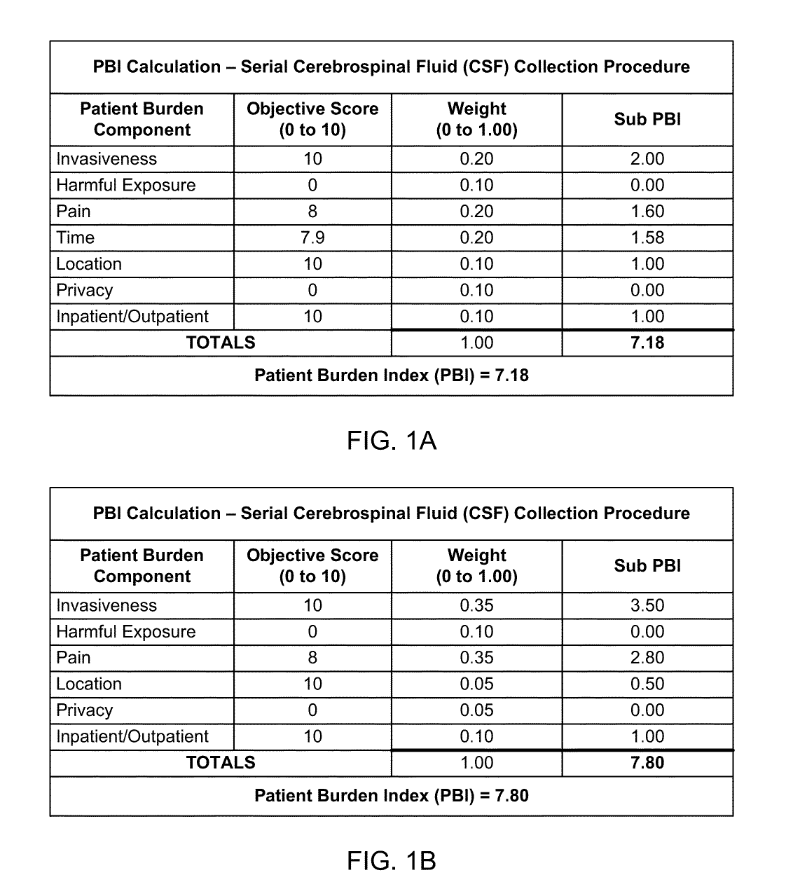

An example of an objective scoring and weighting scheme is shown in FIG. 1A, which shows how the PBI for a serial cerebrospinal fluid (CSF) collection procedure may be calculated. This example includes seven burden components—invasiveness, harmful exposure, pain, time, location, privacy, and inpatient/outpatient. The invasiveness component measures how invasive the particular procedure is. One example is three levels, e.g., invasive, with a score of 10, minimally invasive, with a score of 5, and non-invasive, with a score of 0. The harmful exposure component measures the level of exposure of the patient to potentially harmful elements, such as radiation, noxious fumes, or harmful light. One example is three levels, e.g., high exposure, with a score of 10, some exposure, with a score of 5, and no exposure, with a score of 0. The pain component measures the severity of pain during the procedure. Several pain scales exist, generally containing ten levels, from no pain (0) to severe pain (10). The time component measures how long it takes to perform the procedure on a patient. Since a procedure may last anywhere from a second (or instantaneous) to many hours (there are some procedures that monitor glucose or heart rate that take multiple days) or may not add any time if it takes place simultaneously with another procedure, this score may have ten or more levels, and may be formed as a linear regression between 0 and the procedure that takes the most amount of time. The location component measures the burden associated with where the procedure is performed, e.g., 0 for at a patient's home or office, 3 for at a doctor's office, 7 for at a specialist's office, or 10 for at a hospital. The privacy component measures the burden associated with whether the procedure involves the private areas of the patient's body. One example is three levels, e.g., high privacy concern, with a score of 10, some privacy concern, with a score of 5, and no privacy concern, with a score of 0. The inpatient/outpatient component measures the burden of whether the procedure is inpatient or outpatient. One example is two levels, e.g., inpatient, with a score of 10, and outpatient, with a score of 0. Each of these burden components is assigned a weight. In the weighting scheme illustrated in the example of FIG. 1A, all the weights sum to 1.00.

As shown in FIG. 1A, for each patient burden component, a Sub PBI may be calculated by multiplying each objective score by the corresponding weight. Once all of the Sub PBIs are calculated, then the PBI for the particular clinical trial procedure may be calculated by summing all of the Sub PBIs. Because in this example the score for each component is no more than 10 and because the total weighting sums to no more than 1.00, the max PBI for this procedure is 10. The CSF collection procedure in this example has a PBI of 7.18. Other PBIs calculated by the inventors using this same scale are 6.8 for a spinal puncture, 3.3 for a muscle biopsy, 2.6 for a complete blood count, and 2.6 for a venipuncture (blood draw).

If a clinical trial involves several clinical trial procedures, then the PBIs for all clinical trial procedures may be aggregated to determine the overall PBI for the entire clinical trial. This will be described in more detail later.

FIG. 1B shows another example of an objective scoring and weighting scheme for a serial CSF collection procedure. The scheme illustrated in FIG. 1B differs from the one in FIG. 1A in that the “time” patient burden component is not used, but because all of the weights still sum up to 1.00, at least one of the weights needs to increase. In this case, some increase and some decrease, and the max PBI for this procedure is still 10. Moreover, each Sub PBI and the PBI of FIG. 1B are calculated in the same ways as those in FIG. 1A, and the PBI for this CSF collection procedure changes to 7.80. Again, if a clinical trial involves multiple clinical trial procedures, then the procedure-level PBIs for all clinical trial procedures may be aggregated to determine the trial-level PBI.

Other scoring and weighting scales and schemes may be used. For example, if all the burdens are equally weighted—an averaging algorithm—then the weight for each component in FIG. 1A would be 1/7 (or −0.143) and in FIG. 1B would be ⅙ (or −0.167), so that the total weighting still sums to 1.00. In that case, the PBI in FIG. 1A would decrease from 7.18 to 6.56, and in FIG. 1B from 7.80 to 6.33. If, instead of all the weights totaling 1, each weight equals 1, then the PBI for FIG. 1A would increase to 45.90, out of a max PBI of 70 for this procedure, and the PBI for FIG. 1B would increase to 38.00, out of a max PBI of 60 (since there is no time component).

In addition to scoring the burden for a clinical procedure, the burden for other procedures associated with a clinical trial, such as a questionnaire, could also be scored. The components of this score may include type, time, number of items, and privacy. The type may have three levels, e.g., a clinical assessment, with a score of 10, an interview or standardized test, with a score of 6, and a self-report, with a score of 0. Time may be scored as the number of minutes taken for the questionnaire, and is potentially unlimited, but typically may be from a few minutes to as many as 8 hours (480 minutes). The number of items also is potentially limitless, but typically would be less than 300. Finally, privacy measures how embarrassing or scary the questions may be, and this may be scored from 0 to 5 (or 0 to 10). One algorithm for measuring the burden of a questionnaire could be an averaging algorithm, with no weight or equal weight:

type+time(minutes)+number of items+privacy. (Eq. 1)

Another algorithm could sum weighted scores as described in FIGS. 1A and 1B. And another algorithm may use squaring or square roots so as to not allow certain aspects to outweigh others:

$$\frac{type + \sqrt{time ( minutes )} + \sqrt{number of items} + {privacy}^{2}}{4} ( Eq . 2 ) \qquad$$

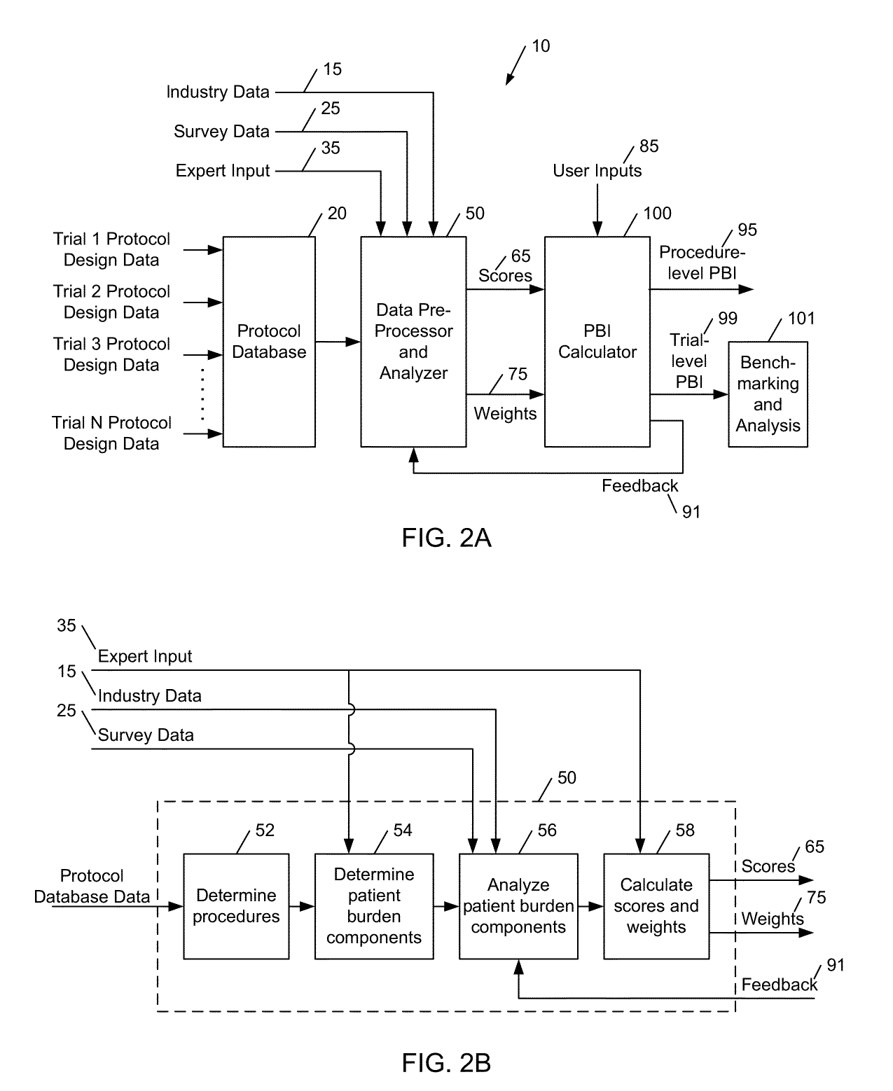

Reference is now made to FIG. 2A, which is a block diagram of a system 10 that includes a Patient Burden Index (PBI) Calculator 100 according to an embodiment of the present invention. Protocols, consisting of series of procedures, may be generated for various clinical trials, e.g., Trial 1, Trial 2, Trial 3, and the procedures collected from those protocols may be stored in a protocol database 20. The data in the protocol database may be transmitted to a data pre-processor and analyzer 50, along with industry data 15, survey data 25, e.g. from patients, and input 35 from experts regarding the patient burden components discussed above. Data pre-processor and analyzer 50 may identify procedures and burden components and analyze the components to calculate scores 65 and weights 75, which may be suggested to a user. The user may then adjust the weights (user inputs 85), and each procedure may then be evaluated using PBI calculator 100 to calculate a procedure-level PBI 95 as well as a trial-level PBI 99. Trial-level PBI 99 may be input to benchmarking and analysis block 101 for further benchmarking. Feedback 91 may be used to update weights 75.

FIG. 2B shows data pre-processor and analyzer 50 in more detail. Protocol database data may be transmitted from protocol database 20 to data pre-processor and analyzer 50, which may then determine in operation 52 the procedures designed for the trials. In operation 54, the patient burden components for those procedures may be determined, possibly using expert input 35. In operation 56, the patient burden components may be analyzed along with the industry data and survey data. Industry data 15 may include insurance information, reference data such as information from standard medical texts, coding information, and recovery time. Industry data 15 may also include clinical data, including mobile health (“mHealth”) data (e.g., data generated from mobile and/or wearable technology). Survey data 25 may include more subjective data, such as emotional burdens and privacy concerns, and may come from patient advocacy groups. Survey data may also include patient-generated data received via wearable devices, implantable devices, or ingestible devices, for example. This data may be more accurate for some of the patient burden components than information communicated by the patient. The analysis in operation 56 may include statistical analysis or other types of mathematical analysis or transformation that quantifies the various inputs and allows different patient burden components to be compared to each other and combined as in Equations 1 and 2. For example, if time is analyzed in minutes, the scale may go from 0 to 480 (8 hours). The time values then may need to be transformed (e.g., scaled or normalized) to be comparable to pain or privacy values that go only from 0 to 10. In operation 58 scores and weights for each burden component may be calculated, possibly again using expert input data. The weights may initially be based on a generic person, then may be modified based on patient population factors, such as age, gender, disease, and/or therapeutic area, The scores and weights may be exported for use in PBI calculator 100.

Feedback 91 may also be used in operation 58 to calculate scores and weights. Initially, the weights may all equal 1 (e.g., for a generic person), and then modified based on patient population factors, and then further modified after receiving feedback as to users' preferences regarding how they weight the various components, such that a consensus may form enough to modify the weights based on those preferences.

Benchmarking and analysis 101 includes providing a study level PBI for a client and then being able to show the industry benchmark (first quartile, median, third quartile) for that same phase and therapeutic area. Such analysis would also allow users to drill down into the study to see their individual PBI component benchmarks as well as industry benchmarks. Further, a user could drill down to the procedure level to see the procedure-level score. A further analysis may show how the burden level may affect the enrollment/screen fail rates as well as the drop-out/completion rates.

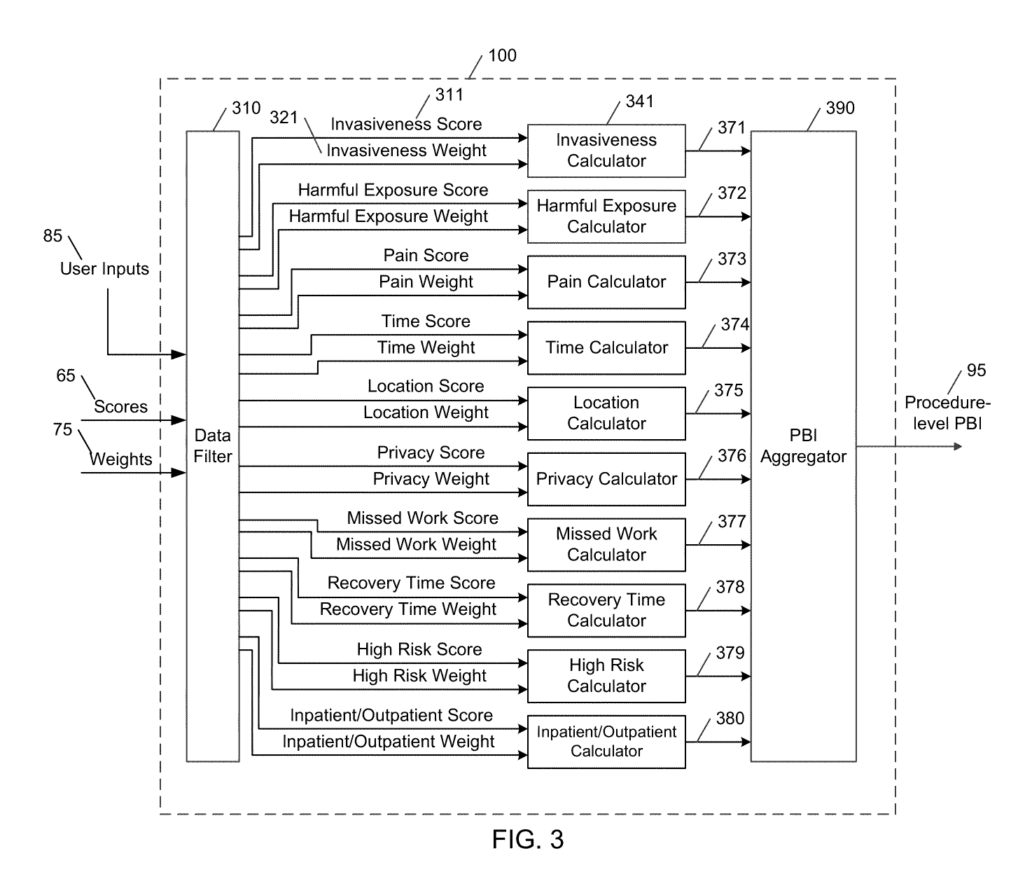

FIG. 3 is a block diagram of a PBI calculator that may use scores 65 and weights 75 shown in FIGS. 2A-2B to calculate procedure-level PBI 95. PBI calculator 100 may include a data filter 310 as well as a sub-calculator, such as invasiveness calculator 341, for each patient burden component—in this example there are ten components and ten sub-calculators. PBI calculator 100 may also take in user inputs 85 and includes a PBI aggregator 390 to aggregate the weighted scores 371-380 (also called Sub PBIs).

Data filter 310 may take in scores 65, weights 75, and user inputs 85 and output the specific score and weight for each patient burden component. For example, data filter 310 may output invasiveness score 311 and invasiveness weight 321 to invasiveness calculator 341, which would calculate Sub PBI 371. Once all of the Sub PBIs have been calculated, they may be aggregated using PBI aggregator 390 to compute procedure-level PBI 95. The various component Sub PBI calculators (e.g., invasiveness calculator 341) illustrated in FIG. 3 are merely exemplary. Calculators for other types of patient burden components may be used in addition to or instead of those shown in FIG. 3.

The blocks shown in FIGS. 2A, 2B, and 3 are examples of modules that may comprise system 10 and do not limit the blocks or modules that may be part of or connected to or associated with these modules. For example, as shown by “Trial N Protocol Design Data,” there are likely many more than three trials whose protocol data are stored in protocol database 20. Protocol database 20 may not be a single database, but may be an aggregate of separate or distributed databases, which may be connected via a private network or a public network such as the Internet (or a combination). Data pre-processor and analyzer 50 is shown separate from PBI calculator 100, but both modules could be physically part of the same apparatus or software package. Moreover, although protocol database 20 is shown connected to data pre-processor and analyzer 50, it may also be connected or accessible to PBI calculator 100. Although user inputs 85 are shown as inputs to PBI calculator 100, there may also be user inputs to protocol database 20 and/or data pre-processor and analyzer 50, either as part of or different from industry data 15, survey data 25, and expert input 35. User inputs may be used to calculate scores 65 and/or weights 75. Weights may be objective—based on an analysis of patients and patient populations—or subjective—based on survey data or a particular customer's preferences. To calculate a trial-level PBI, there may be a trial-level PBI aggregator either part of PBI calculator 100 or outside of it that aggregates procedure-level PBIs. The blocks in FIGS. 2A, 2B, and 3 may be implemented in software or hardware or a combination of the two, and may include processors, memory, and software instructions executed by the processors.

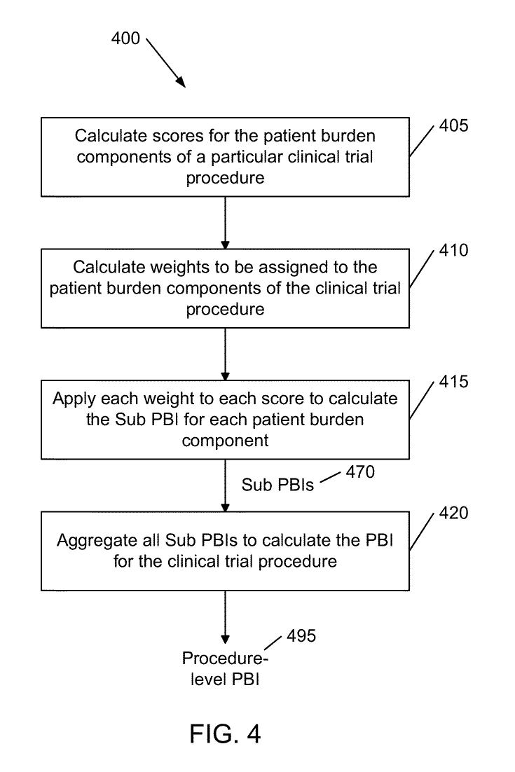

Reference is now made to FIG. 4, which is a flowchart 400 illustrating one way to calculate the PBI for a clinical trial procedure. In operation 405, each objective score for each patient burden component of a clinical trial procedure may be calculated, e.g., using data pre-processor and analyzer 50. Each such score may reflect an objective measurement of a particular burden imposed on the patient by a particular clinical trial procedure. The objective score may have a constant value.

In operation 410, a weight may be assigned to each patient burden component that was assigned an objective score. Each assigned weight may be calculated based on the perspective of a patient, and may be subjective and take into consideration how a patient feels about a particular clinical procedure. Each weight may be pre-assigned based on, for example, the age, gender, or other characteristics, such as medical condition (e.g., cancer patient), of a patient or a group of patients. For a given set of objective scores assigned to the burden components of a clinical trial procedure, the set of weights may vary depending on, for example, the age of the patient or group of patients for which the PBI is being calculated.

In operation 415, each weight may be applied to each objective score to calculate the Sub PBI 470 for each patient burden component. The Sub PBI may be calculated by multiplying the objective score and the weight, or by some other algorithm, such as shown in Equations 1 and/or 2.

In operation 420, procedure-level PBI 495 may be calculated by aggregating, for example, by summing up the Sub PBIs 470. However, other methods and algorithms are possible to calculate the procedure-level PBI 495, such as shown in Equations 1 and/or 2. Furthermore, the weights calculated for each patient burden component may be assigned independently from how the objective scores may be assigned.

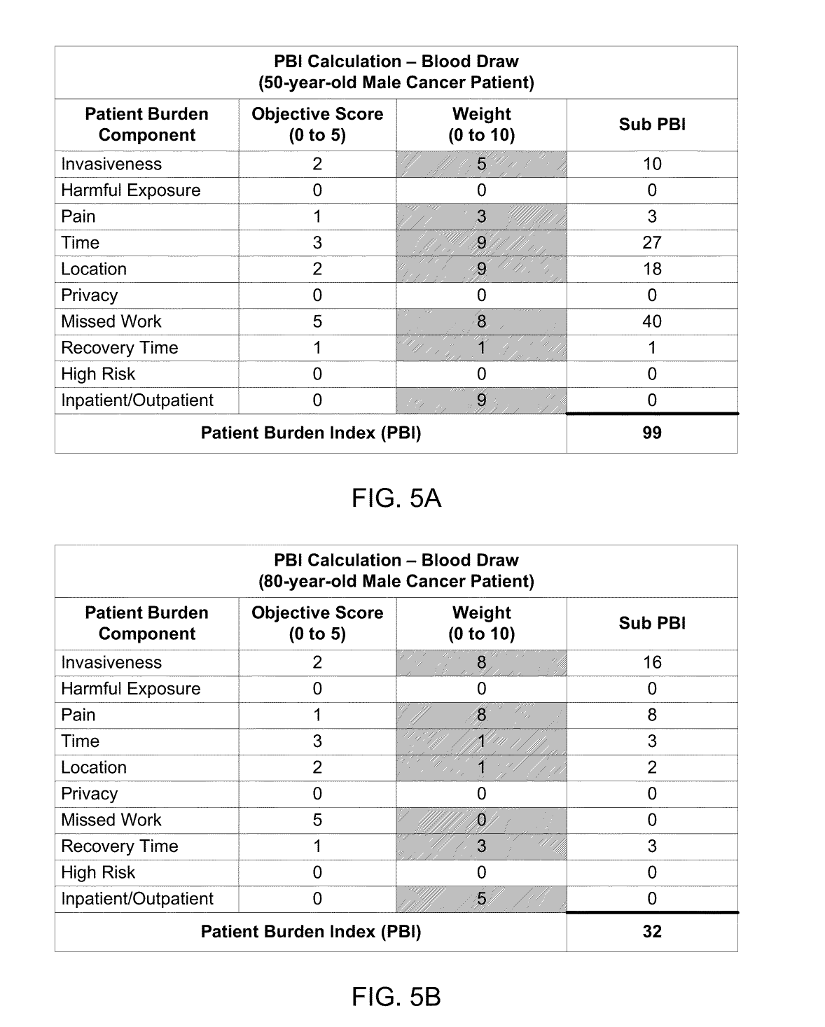

Reference is now made to FIGS. 5A and 5B, which are two tables illustrating two different sets of calculations of procedure-level PBIs associated with a blood draw procedure (a clinical trial procedure) for two different patients. Both of these patients are male and have cancer, but differ in age—one is 50 years old and the other one is 80 years old. As shown in FIGS. 5A and 5B, the objective scores for the various patient burden components in both tables may be the same—they do not vary for a given procedure. However, the score may be adjusted for a number of other aspects, such as age of the patient as contemplated here.

Some of the patient burden components in FIGS. 5A and 5B are described above in connection with FIGS. 1A and 1B, so will not be described again here. The missed work component measures the burden associated with whether the procedure causes the patient to miss work, e.g., 0 for no missed work, 3 for moderate work missed, or 5 for a lot of work missed. The recovery time component measures the length of time needed for recovery after the procedure, e.g., 0 for short recovery time, 3 for moderate recovery time, or 5 for long recovery time. The high risk component measures the burden associated with whether the procedure is considered to be high risk, e.g., 0 for no risk, 3 for moderate risk, or 5 for high risk.

Note that the scores for FIGS. 5A and 5B are on a scale of 0 to 5, whereas those for FIGS. 1A and 1B are on a scale of 0 to 10. This is to show that different scales may be used, and there may be normalization. Similarly, whereas each weight for FIGS. 1A and 1B may be from 0 to 1 and all the weights add up to 1.00, in FIGS. 5A and 5B, each weight may be from 0 to 10, but there is no prescribed total for the weights in these tables. So long as the PBI for any particular procedure or clinical trial uses the same scales, the appropriate comparisons may be made.

In FIGS. 5A and 5B, while the scores assigned to the various patient burden components are the same for the two patients, the weights assigned to the components may differ due to the different perspectives of the 50-year-old patient and the 80-year-old patient. Where the weights differ, they are highlighted in their respective entries in tables shown in FIGS. 5A and 5B. Such variations may result in different Sub PBIs, as well as the resultant procedure-level PBIs. For example, the “Invasiveness” component may be assigned a weight of 5 for the 50-year-old patient, compared to an 8 for the 80-year-old patient, because the invasiveness of the blood draw procedure, which involves a minor puncture into the skin, may not be perceived to be as high for a 50-year-old compared to an 80-year-old. Hence, a higher weight is assigned for “Invasiveness” for the 80-year-old patient. In another embodiment, in which a weight for a component may not take into account a specific factor such as age, age or other factors may be taken into account using an adjustment coefficient.

As further illustrations, the 50-year-old patient may perceive the pain associated with the blood draw procedure to be low and tolerable, while the 80-year-old patient may perceive it as a highly painful procedure. Thus, a lower weight (3) and a higher weight (8) may be assigned according to their respective perspectives, as shown in FIGS. 5A and 5B. Again, in another embodiment, age or other factors may be taken into account using an adjustment coefficient. In terms of the “Time” component, the 50-year-old patient may be employed full-time and have children to take care of. He may perceive that the time spent undergoing a blood draw to be more burdensome, and hence a higher weight is assigned, when compared to the perspective of the 80-year-old patient who may be retired and have more free time. For the “Missed Work” component, the 50-year-old patient may perceive that taking time off from work is a higher burden, and hence a higher weight to that component is assigned. In contrast, the 80-year-old patient likely no longer works, so there is no concern from his perspective for missing work. Similarly, the weights assigned to “Location,” “Recovery Time,” and “Inpatient/Outpatient” for these two patients all differ due to their different perspectives.

For some components, the weights will be the same for the different patients. As shown in the tables in FIGS. 5A and 5B, both patients may not perceive the harmful exposure as a burden in connection with a blood draw. Thus, the same weight (0) is assigned to that component. Similarly, for the “Privacy” and “High Risk” patient burden components, both patients perceive them in the same way—with a weight of 0.

As shown in FIGS. 5A and 5B, the procedure-level PBI calculated for the 50-year-old patient in undergoing the blood draw is 99, which is much higher than the one calculated (32) for the 80-year-old patient. The different patient burden components shown in FIGS. 5A and 5B are merely exemplary, and not the only ones that may be used with the system and method described herein. Other patient burden components exist and may be taken into consideration when calculating the PBI. Additionally, the objective scores and weights used in FIGS. 5A and 5B are not the only possibilities that may be used with the system and methods described herein.

Furthermore, even though the procedure-level PBIs in FIGS. 5A and 5B may be obtained by summing up the Sub PBIs that may be obtained by multiplying the corresponding objective scores and weights, such a calculation method is merely exemplary, and other methods and algorithms are possible, for example those in Equations 1 and/or 2 and others.

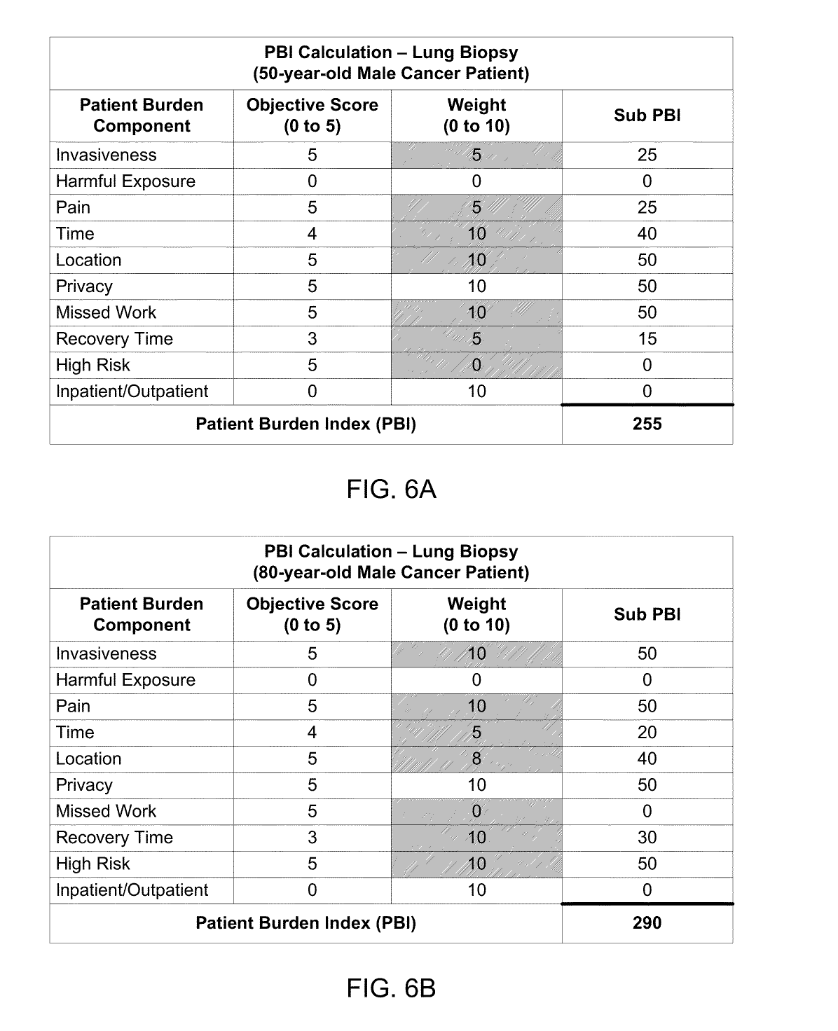

Reference is now made to FIGS. 6A and 6B, which are two tables similar to those in FIGS. 5A and 5B that illustrate two different sets of calculations of procedure-level PBIs associated with a lung biopsy for the same 50-year-old and 80-year-old male cancer patients described above. As shown in FIGS. 6A and 6B, the objective scores for the various patient burden components in both tables may be exactly the same for this procedure, but differ from those of the previous procedure. Again, the weights assigned to the various patient burden components are not all the same due to the different perspectives of the two patients. Where the weights differ, they are highlighted in their respective entries in tables shown in FIGS. 6A and 6B.

Similar to the discussion in connection with FIGS. 5A and 5B above, such variations may result in different Sub PBIs, as well as the resultant procedure-level PBIs. For example, the “Invasiveness” patient burden component may be assigned a weight of 5 for the 50-year-old patient, compared to a 10 for the 80-year-old patient. The recovery time associated with the biopsy may be acceptable to the 50-year-old (a weight of 5), but the 80-year-old patient may perceive it as highly burdensome (weight of 10). In terms of the “High Risk” component, the 50-year-old patient may feel that the biopsy is not a high risk procedure (i.e., he has a low chance of dying). However, the 80-year-old patient, who may be weaker in health and physical condition, may feel that the biopsy is potentially life-threatening. Therefore, a much higher weight (10) is used in the case of the 80-year-old patient, as compared to the weight for the 50-year-old patient, for the “High Risk” component.

As in FIGS. 5A and 5B, some components have the same weights in both FIGS. 6A and 6B. As shown in the tables of FIGS. 6A and 6B, both patients may not perceive the harmful exposure as a burden in connection with a biopsy. Thus, the same weight (0) is assigned to that component. For the “Privacy” and “Inpatient/Outpatient” patient burden components, both patients equally perceive them as extremely burdensome (weight of 10).

In FIGS. 6A and 6B, the procedure-level PBI calculated for the 50-year-old patient for a lung biopsy is 255, which is lower than the one calculated (290) for the 80-year-old patient. In other words, this clinical trial procedure (i.e. lung biopsy) is more burdensome for the 80-year-old patient than it is for the 50-year-old patient.

The different patient burden components shown in FIGS. 6A and 6B are merely exemplary, and not the only ones that may be used with the system and method described herein. Other patient burden components exist and may be taken into consideration when calculating the PBI. Additionally, the objective scores and weights used in FIGS. 6A and 6B are not the only possibilities that may be used with the system and methods described herein. Furthermore, even though the procedure-level PBIs in FIGS. 6A and 6B may be obtained by summing up the Sub PBIs that may be obtained by multiplying the corresponding objective scores and weights, such a calculation method is merely exemplary, and other methods and algorithms are possible, for example those in Equations 1 and/or 2 and others.

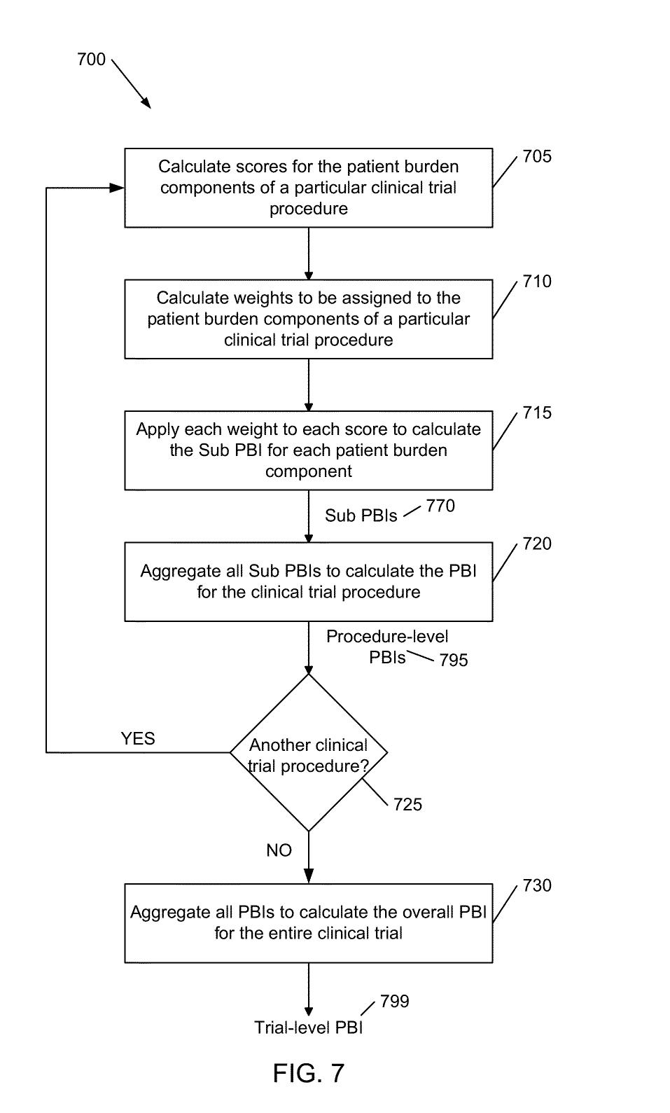

Reference is now made to FIG. 7, which is a flowchart 700 illustrating another embodiment of the present invention, showing a way in which an overall trial-level PBI 799 may be calculated. Flowchart 700 is very similar to flowchart 400 shown in FIG. 4—operations 705 to 720 are essentially the same as operations 405 to 420. Flowchart 700 adds operations 725 and 730. Operation 725 asks if there is at least one more clinical trial procedure left to have its PBI calculated. If so, then the flow will return to operation 705 to restart the process of computing the PBI for that clinical trial procedure. If there is no other clinical trial procedure left to have its PBI calculated, then, in operation 730, the overall PBI for the entire clinical trial may be computed based on all procedure-level PBIs 795. Such a calculation of trial-level PBI 799 may be performed by aggregating, for example, by summing up all procedure-level PBIs 795. Although not pictured, a trial-level PBI aggregator that aggregates the procedure-level PBIs 795 may be part of PBI calculator 100. Other methods and algorithms may be used to determine trial-level PBI 799.

Besides the operations shown in FIGS. 4 and 7, other operations or series of operations are contemplated to calculate procedure-level and trial-level PBIs. For example, uploading protocol design data to the protocol database may include other operations and may not be performed at one time, e.g., the uploading may be performed daily or weekly. Such uploading may be performed via a network connection, such as the Internet or via Wi-Fi or a public or private telephone network. Such uploading may be automatic, performed as part of maintenance or as part of an electronic data capture (EDC), clinical trial management system (CTMS), or grant management system, or may be manual, e.g., by manually transferring protocol design data files to the database. Moreover, the actual orders of the operations in the flow diagrams in FIGS. 4 and 7 are not intended to be limiting, and the operations may be performed in any practical order.

The present invention may be used to help sponsors, trial sites, trial designers, patients, and even regulators evaluate the patient burden associated with a particular clinical trial procedure, or the entire clinical trial comprising multiple procedures. One benefit of the present invention is that a sponsor may more realistically and usefully understand the PBI and associated patient burden so that it can design a clinical study that may minimize the PBI. Another benefit is that the principal investigator or patient may be able to quickly compare the PBI of a proposed clinical trial procedure against another procedure in order to assess the additional burdens on the site or the patient for participating in the study. This index may be used in protocol development to indicate the likelihood of successful trial enrollment and thereby reduce the pervasive industry issues surrounding delayed trial enrollment.

A further benefit is that a site or sponsor may be better equipped to negotiate execution of a clinical trial protocol, and they may work with each other to reduce the trial-level PBI of the proposed clinical trial.

Aspects of the present invention may be embodied in the form of a system, a computer program product, or a method. Similarly, aspects of the present invention may be embodied as hardware, software or a combination of both. Aspects of the present invention may be embodied as a computer program product saved on one or more computer-readable media in the form of computer-readable program code embodied thereon.

For example, the computer-readable medium may be a computer-readable signal medium or a computer-readable storage medium. A computer-readable storage medium may be, for example, an electronic, optical, magnetic, electromagnetic, infrared, or semiconductor system, apparatus, or device, or any combination thereof.

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Computer program code in embodiments of the present invention may be written in any suitable programming language. The program code may execute on a single computer, or on a plurality of computers. The computer may include a processing unit in communication with a computer-usable medium, wherein the computer-usable medium contains a set of instructions, and wherein the processing unit is designed to carry out the set of instructions.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. An improved clinical trial patient burden calculating system, comprising:
a data analyzer configured to calculate scores and weights for patient burden components;
a plurality of data calculators configured to calculate a respective plurality of sub patient burden indexes based on the patient burden component scores and weights; and
an aggregator configured to calculate a procedure-level patient burden index based on aggregation of the sub patient burden indexes.

2. The improved system of claim 1, further comprising a data filter configured to separate aggregated patient burden component scores and weights into component scores and weights.

3. The improved system of claim 1, wherein the patient burden components include invasiveness, pain, time, and privacy.

4. The improved system of claim 3, wherein the patient burden components include harmful exposure and location.

5. The improved system of claim 1, wherein the data analyzer is configured to determine clinical trial procedures based on clinical trial protocol design data.

6. The improved system of claim 1, wherein the data analyzer is configured to determine patient burden components based on clinical trial protocol design data.

7. The improved system of claim 1, further comprising a second aggregator configured to aggregate procedure-level patient burden indexes into a trial-level patient burden index.

8. The improved system of claim 1, wherein the data analyzer is configured to use feedback to calculate scores and weights for patient burden components.

9. The improved system of claim 1, wherein the aggregator calculates the procedure-level patient burden index by summing together the sub patient burden indexes.

10. An improved method for calculating clinical trial patient burden, comprising:
receiving protocol design data from one or more clinical trial designs, the designs including at least one clinical trial procedure;
determining patient burden components of said at least one clinical trial procedure;
analyzing the burden components;
calculating a score and a weight for at least two burden components; and
calculating a procedure-level patient burden index based on a weighted score.

11. The method of claim 10, further comprising receiving industry data and calculating the procedure-level patient burden index based on the industry data.

12. The method of claim 10, further comprising receiving user input data and calculating the procedure-level patient burden index based on the user input data.

13. The method of claim 12, wherein the user input data comprises an age of a clinical trial patient and the age is used to calculate an adjustment factor for the score, the weight, or both.

14. The method of claim 12, wherein the user input data comprises an age of a clinical trial patient and the age is used to calculate the score, the weight, or both.

15. The method of claim 10, further comprising receiving survey data and calculating the procedure-level patient burden index based on the survey data.

16. The method of claim 15, wherein the survey data comprises patient-generated data received via a wearable, implantable, or ingestible device.

17. The method of claim 10, further comprising:
calculating a procedure-level patient burden index for each of a plurality of procedures; and
calculating a trial-level patient burden index by aggregating said procedure-level patient burden indexes.
